(19) United States
(12) Patent Application Publication
(10) Pub. No.: US 2024/0409819 A1
(43) Pub. Date: Dec. 12, 2024

(54) REPLACING THE USE OF AIR AND STEAM WITH OXYGEN AND CARBON DIOXIDE IN FLUIDIZED CATALYTIC CRACKING UNITS

(71) Applicant: Kerogen Systems, Incorporated, Mill Valley, CA (US)

(72) Inventors: Otto John SCHNEIDER, Mill Valley, CA (US); Christopher D. GOSLING, Roselle, IL (US); Paul S. OWEN, London (GB); Robert SWINDOLL, Vernal, UT (US)

(21) Appl. No.: 18/740,324

(22) Filed: Jun. 11, 2024

Related U.S. Application Data
(60) Provisional application No. 63/472,388, filed on Jun. 12, 2023.

(51) Int. Cl. C10G 11/18; B01J 38/30

(52) U.S. Cl. CPC C10G 11/182; B01J 38/30; C10G 2300/4081; C10G 2300/708

(57) ABSTRACT

The disclosed invention enables environmentally friendly fluidized catalytic cracking of crude oil. A process of converting a hydrocarbon feedstock to multiple products comprises conveying a starting hydrocarbon feedstock to a riser reactor configured to receive a catalyst to catalytically crack the starting hydrocarbon feedstock, wherein the catalyst is fluidized by a lift gas, and wherein the catalyst cokes; transferring the coked catalyst to a regenerator, configured to oxidize the coked catalyst with a coke-oxidation gas, to form a regenerated catalyst and a carbon-oxides stream, wherein the coke-oxidation gas from 50 mol % to 90 mol % CO₂; transferring the regenerated catalyst to the riser reactor; and fractionating the riser-reactor reaction products in a distillation column. CO₂ contained within the coke-oxidation gas is obtained from a recycle gas derived from recovering CO₂ from the carbon-oxides stream. The recycle gas contains from 80 mol % CO₂ to 100 mol % CO₂.

### PRIORITY DATA

This non-provisional patent application claims priority to U.S. Provisional Patent App. No. 63/472,388, filed on Jun. 12, 2023, which is hereby incorporated by reference herein.

### FIELD OF THE INVENTION

The present invention generally relates fluidized catalytic cracking of hydrocarbons from a variety of sources, such as crude oil.

### BACKGROUND OF THE INVENTION

Crude oil is a complex mixture of many hundreds or thousands of different molecules. Some of these molecules, particularly those with high molecular weights, are of low economic value. Conventionally, these lower-value products have been converted or upgraded by “cracking” them into smaller, more useful, and more valuable molecules.

In the early days of crude oil refining, cracking was achieved by heating the low-value heavy fractions to high temperatures where thermal cracking reactions occur. Subsequently, it was discovered that catalytic agents improve reaction selectivity and thus increases the yields of higher-value products such as motor fuels and chemicals. The process technologies developed to realize this discovery have become known as the Fluidized Catalytic Cracking (FCC), which is carried out in a Fluidized Catalytic Cracking Unit (FCCU).

The FCC process has been studied, patented, erected, and operated by many companies over many decades. Feedstocks for refinery FCCUs tend to be less valuable, high-molecular-weight components, typically atmospheric gas oils (AGO) and vacuum gas oils (VGO) having a boiling range between 550° F. (300° C.) and 1022° F. (550° C.). Early designs were based on hot oil and catalyst mixing in a fluidized bed in a large reactor volume. Over time, the process has been refined to shift the bulk of the cracking reactions to what is called the Riser. The Riser is a vertical cylinder into which the feedstock to be cracked is introduced, along with a lift gas and hot powdered zeolitic catalyst. The feedstock is injected near the base of Riser, conventionally using steam as a dispersal medium, such that the feedstock is atomized, forming tiny droplets. These droplets contact the hot catalyst which has been fluidized by the lift gas, causing the droplets to vaporize. The expanding vapor, lift gas and fluidized catalyst travel up the Riser. The vaporized feedstock, in intimate contact with the hot catalyst, undergoes cracking to produce lower-molecular-weight components.

Catalytic cracking is complex, and many rapid reactions are involved. The overall process is endothermic, and energy must be supplied to maintain the reactions. To avoid excess cracking, contact times in the upper Riser are kept short, typically no more than five seconds. Products of the reaction include smaller hydrocarbon molecules, carbon deposited on catalyst, and other compounds. The carbon, along with some chemically bonded hydrogen, metals, and other impurities, is deposited on the catalyst as coke. These coke deposits reduce catalyst activity. To overcome this problem, the coked spent catalyst is transported to a Regenerator. Removal of coke deposits and reactivation of the catalyst occurs by oxidation of the coke in the Regenerator using air introduced via a blower. The coke is combusted and forms carbon monoxide, carbon dioxide, water, and some other compounds. Combustion of the coke heats the catalyst; the hot regenerated catalyst is returned to the Riser forming a continuous cracking-regeneration cycle.

The dominance of the FCC process is based on its ability to achieve a high conversion of heavy low-value feedstock at high energy efficiency to higher-value products. Beneficially, the process also reduces the sulfur, nitrogen, and metals content of the high-value cracked products. FCC units have become the single most important refinery operation with regards to production and profitability, particularly in the U.S. but also worldwide. For many decades, FCC operation has been focused on maximizing production of high-octane gasoline and other fuels. Recent modifications to the process add value by skewing production towards chemical feedstocks such as olefins (e.g., propylene) instead of fuels. Demand for petrochemical feedstocks, including propylene, is expected to increase while demand for fuels is forecast to decrease. As world reserves of lighter, sweeter crude oils have been depleted, FCC technology and catalysts have been developed to enable direct processing of heavier crudes.

The environmental impact of existing FCC units is significant. Large quantities of carbon dioxide and pollutants such as oxides of sulfur (SOₓ) and nitrogen (NOₓ), and particulate matter are released. Energy requirements, typically met by burning fossil fuels, and the need for large quantities of steam exacerbate this problem. Capturing or removing the large quantities of carbon dioxide (CO₂) produced is complicated by its relatively low concentration in flue and other waste gases. CO₂ emissions from FCC units account for approximately 15% to 20% of total refinery carbon emissions—around 0.5% of total U.S. carbon emissions (as of 2019). Addressing these environmental challenges requires a combination of technological advancements, regulatory compliance, and sustainable practices that can be economically implemented.

### SUMMARY OF THE INVENTION

The present invention addresses the aforementioned needs in the art, as will now be summarized and then further described in detail below.

Some variations provide a process of converting a hydrocarbon feedstock to multiple products, the process comprising:
(a) providing a starting hydrocarbon feedstock;
(b) conveying the starting hydrocarbon feedstock to a riser reactor, wherein the riser reactor is configured to receive a catalyst to catalytically crack the starting hydrocarbon feedstock and to generate riser-reactor reaction products, wherein the catalyst is fluidized by a lift gas, and wherein the catalyst becomes a coked catalyst within the riser reactor;
(c) transferring the coked catalyst to a regenerator, configured to oxidize the coked catalyst with a coke-oxidation gas, to form a regenerated catalyst and a carbon-oxides stream, wherein the coke-oxidation gas contains from about 9 mol % to about 35 mol % oxygen and from about 50 mol % to about 90 mol % carbon dioxide;
(d) transferring the regenerated catalyst from the regenerator to the riser reactor; and
(e) fractionating the riser-reactor reaction products in a FCC main column, to generate light ends, heavy cracked naphtha, light cycle oil, heavy cycle oil, and a bottoms stream,
wherein at least a portion of the carbon dioxide, contained within the coke-oxidation gas, is obtained from at least a portion of a recycle gas, wherein the recycle gas is derived from recovering CO₂ from the carbon-oxides stream, and wherein the recycle gas contains from about 80 mol % CO₂ to 100 mol % CO₂.

In some embodiments, the recycle gas contains from about 80 mol % to about 95 mol % carbon dioxide. In certain embodiments, the recycle gas contains from about 85 mol % to about 95 mol % carbon dioxide.

In some embodiments, the coke-oxidation gas contains from about 55 mol % to about 90 mol % carbon dioxide. In certain embodiments, the coke-oxidation gas contains from about 58 mol % to about 86 mol % carbon dioxide.

In some embodiments, the lift gas comprises or consists essentially of another portion of the recycle gas. Whether or not the lift gas uses some of the recycle gas, the lift gas may contain from about 80 mol % to 100 mol % carbon dioxide, such as from about 85 mol % to about 95 mol % carbon dioxide.

In some embodiments, step (b) utilizes a feedstock injector dispersant that comprises or consists essentially of another portion of the recycle gas. The feedstock injector dispersant is distinct from the lift gas. Whether or not the feedstock injector dispersant uses some of the recycle gas, the feedstock injector dispersant may contain from about 80 mol % to 100 mol % carbon dioxide, such as from about 85 mol % to about 95 mol % carbon dioxide.

In some embodiments, the carbon-oxides stream from step (c) is fed to a CO boiler. Optionally, another portion of the recycle gas is fed to the CO boiler. Whether or not the CO boiler uses some of the recycle gas, the CO boiler may be fed a gas stream containing from about 80 mol % to 100 mol % carbon dioxide, such as from about 85 mol % to about 95 mol % carbon dioxide.

In some embodiments, the coke-oxidation gas is a first portion of the recycle gas, and the lift gas is a second portion of the recycle gas.

In some embodiments, the coke-oxidation gas is a first portion of the recycle gas, the lift gas is a second portion of the recycle gas, and step (b) utilizes a feedstock injector dispersant that is a third portion of the recycle gas.

In some embodiments, the coke-oxidation gas is a first portion of the recycle gas, the lift gas is a second portion of the recycle gas, step (b) utilizes a feedstock injector dispersant that is a third portion of the recycle gas, and a fourth portion of the recycle gas is fed to a CO boiler that receives the carbon-oxides stream from step (c).

In some embodiments, step (e) comprises pre-flashing the riser-reactor reaction products in a FCC pre-flash unit to generate a vapor stream and a liquid stream, followed by conveying the liquid stream to the FCC main column.

In some embodiments, the heavy cycle oil from step (e) is recycled to the riser reactor.

The process is preferably continuous or semi-continuous.

### BRIEF DESCRIPTION OF THE DRAWINGS

Various embodiments may be understood with reference to the drawings, which are not intended to limit the invention in any way.

FIG. 1 depicts a block-flow diagram of an exemplary fluidized catalytic cracking process in some variations of the invention. Dashed lines indicate an optional process or stream.

FIG. 2 depicts an exemplary fluidized catalytic cracking unit consisting of a Regenerator, a Reactor-Riser, a Catalyst Cooler, and associated standpipes.

### DETAILED DESCRIPTION OF EMBODIMENTS OF THE INVENTION

The systems, methods, and compositions of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

The use of air and steam in existing FCC units is generally based on historical precedent. The invention described herein enables individuals skilled in the art to use more efficient and environmentally friendly solutions.

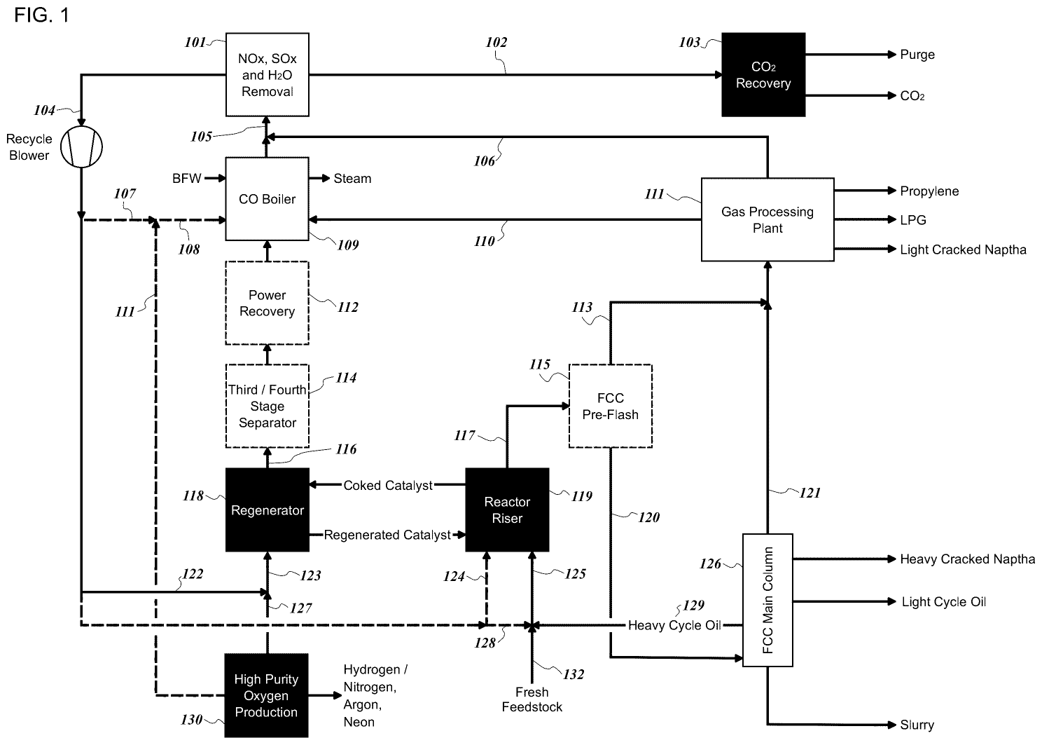

Air is conventionally used for Regenerator coke combustion in the FCC process. In the present invention, the regenerator air is replaced with a mixture of high-purity oxygen and a stream rich (≥80 mol %) in carbon dioxide. This generates a flue gas stream similarly rich in carbon dioxide. As depicted in the block-flow diagram of FIG. 1 the flue gas (116), with some further processing, can be recycled (104). The Recycle Gas stream becomes the source of the carbon dioxide for the high-purity oxygen/carbon dioxide mixture. Beneficially, recovery of excess carbon dioxide from the flue gas becomes considerably easier and more economical.

Conventional FCC art utilizes steam for many important functions such as riser lift gas, stripping gas, feedstock dispersal, and other utility uses. Using the disclosed technology, the steam may be substituted wholly, or in part, with CO₂-rich Recycle Gas.

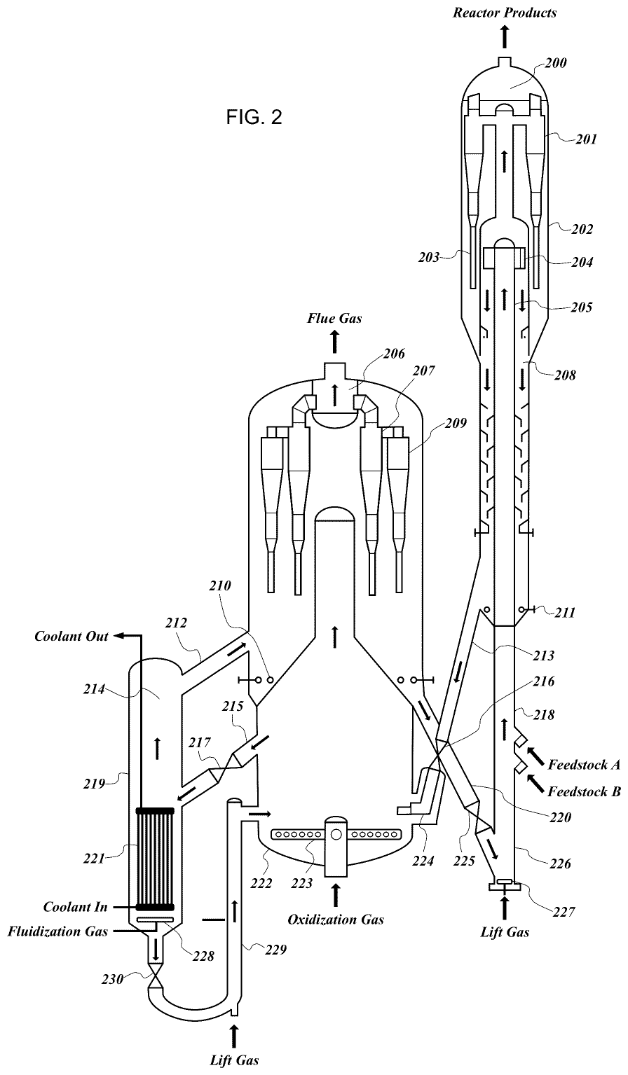

FIG. 2 depicts a typical side-by-side style FCC, with separate riser-reactor, regenerator, and catalyst cooler units connected via standpipes.

With reference to FIG. 1, those skilled in the art will be aware of the functions of both the Regenerator (118) and Riser-Reactor (119). In the FCC unit depicted in FIG. 2, catalytic cracking of high-molecular-weight feedstocks in the Riser (218) results in the deposition of coke on the catalyst. This coke, comprising mostly carbonaceous material, deactivates the catalyst by blocking active sites. The Regenerator restores catalytic activity by oxidizing the coke to CO and/or CO₂.

In FIG. 2, spent (coked) catalyst flows from the Stripper (208) section of the Reactor-Riser (218) to the Regenerator (222) via a standpipe (213), its flowrate controlled by a slide valve (216). There is known art regarding the spent catalyst feed device (224); the present invention is agnostic to the specific design. Within the Regenerator, the spent catalyst is fluidized by a gas containing an oxidizing agent. In existing art, this gas generally takes the form of air containing oxygen, which is the oxidizer. Air is typically supplied by a blower at pressures between 35 psig (2.5 barg) to 50 psig (3.5 barg) and ambient temperature. Typical oxygen-to-coke ratios range from 0.5 to 1.5 on a mass basis. There is known art describing the design and operation of the oxidizing gas distributor (223); the present invention is agnostic to its design subject to certain considerations.

Air is approximately 78 mol % nitrogen and 21 mol % oxygen; the remaining 1 mol % comprises mostly argon with smaller quantities of carbon dioxide, carbon monoxide, neon, and helium. The typical operating temperature of the Regenerator ranges between 1,300° F. (700° C.) and 1,380° F. (750° C.). At these temperatures, nitrogen does not play a significant role in the combustion reactions. Thus, while significant quantities of carbon dioxide (and carbon monoxide) are produced during combustion of the coke, the CO₂ and CO remain dilute relative to this large quantity of inert nitrogen. Typically, flue gas would comprise between 10 mol % to 20 mol % carbon dioxide, significantly complicating its recovery.

While the nitrogen ordinarily found in air does not play a significant role in combustion within the Regenerator, N₂ does act to carry heat away from the reaction. Thus, nitrogen acts to reduce maximum combustion temperatures. Without this effect a Regenerator fed with pure oxygen could quickly exceed maximum design temperatures. This could lead to undesired reactions, destroyed catalyst, damaged vessel internals, and even failure of the vessel itself.

Preferred embodiments of this invention replace the use of air as the Oxidization Gas in the Regenerator (123) with a mixture of high-purity oxygen (127) and recycled Regenerator flue gas, which is referred to herein as “Recycle Gas” (104). The Recycle Gas 104 may further be split into stream 122 and optionally also into streams 107, 124, and 128. The mixture of streams 127 and 122 becomes stream 123 which is injected into the Regenerator in FIG. 1.

In this specification, “high-purity oxygen” is defined as being at most 100 mol %, no less than 90 mol %, and typically 95 mol % oxygen. By eliminating the use of air for combustion, the massive quantities of nitrogen (and other gases) air contains are also eliminated; this Recycle Gas (104) will therefore be rich (≥80 mol %) in carbon dioxide. Like nitrogen, carbon dioxide will not play a role in combustion at these temperatures. CO₂ thus acts similarly to nitrogen in moderating maximum combustion temperatures by carrying heat away from the reactions.

High-purity oxygen for all the embodiments presented herein can be obtained as one product of air separation. Air separation is a process for which there are many existing technologies; cryogenics and adsorption being two such examples. Electrolysis of water offers a further route to oxygen production. By using renewable energy to produce oxygen, the environmental cost of production can be significantly reduced. Alternatively, oxygen may be provided via pipeline, tanker, railcar, or other off-site source. Economics would typically be the prime driving factor in determining how and where oxygen is obtained. In the case of electrolysis, access to a plentiful supply of water would also play a significant role in selection of the technology. When making high-purity oxygen from a feedstock, there will be co-products other than O₂. Such co-products could be used elsewhere in the plant or sold. For air separation, co-products may include nitrogen, argon, and neon. When water electrolysis is used, hydrogen (H₂) is a valuable co-product. Preferred embodiments of this invention are agnostic to which process technology or delivery method is used to obtain the high-purity oxygen (130).

In one embodiment of this invention, the carbon dioxide component of the Recycle Gas (104) replaces the nitrogen found in air on a mole-for-mole basis, i.e., 1 mol of carbon dioxide for 1 mol of nitrogen. The Recycle Gas to Regenerator (122) is combined with high-purity oxygen (127) to form Oxidation Gas (123), which is also referred to as coke-oxidation gas. Depending on the desired concentration of oxygen, the resulting composition of the Oxidation Gas will range from 9.5 mol % to 35 mol % oxygen and 58 mol % to 86 mol % carbon dioxide. The balance includes light hydrocarbons, unconsumed oxygen and small quantities of nitrogen and other gases.

It is important to consider how differences in the properties of Oxidation Gas versus that of air used in existing art may impact FCC operation. Carbon dioxide is 1.5× the molecular weight, 1.5× the density, and averages 1.3× the molar heat capacity, relative to nitrogen over the temperature range of interest. As carbon dioxide does not play a significant role in combustion, it follows—given CO₂'s larger heat capacity—more heat will be removed from the Regenerator compared to nitrogen on a like-for-like basis. As a result, under otherwise similar process operating conditions, the temperatures in the Regenerator will be lower than temperatures in conventional FCCUs operated with nitrogen-rich air.

Operating the Regenerator at lower temperatures may have both beneficial and detrimental effects on overall performance for a given feedstock at otherwise comparable operating conditions. Unless otherwise compensated for, lower temperatures may lead to incomplete combustion of carbon monoxide which may require additional afterburning at the Regenerator outlet. Also, unless otherwise compensated for, lower Regenerator temperatures may mean lower Riser catalyst temperatures. These lower temperatures will have an impact on cracking within the Riser, reducing both conversion and coking. Lower temperatures may also be seen as an advantage—by increasing capacity to burn coke for a given Regenerator size as compared to existing FCC regenerator art. In a Regenerator, more coke may be burned, and temperatures can be maintained in a more typical operating range of 1,290° F. (700° C.) to 1,380° F. to (750° C.). In turn, this may have a beneficial effect on catalyst maintenance, particularly in operations running high Conradson Carbon Residue (CCR). The overall effect of replacing nitrogen with Recycle Gas can enable an increase in FCC throughput of between 25% and 35% for the same size regenerator vessel. Thus, the capital costs of a Regenerator may be significantly lower than for a conventional FCC operating at the same feedstock quality and quantity. Alternatively, it may be possible to increase use of lower cost, high Conradson Carbon Residue (CCR) feedstocks, renewable organic feedstocks, or synthetic feedstocks such as derived from kerogen—thereby improving FCC profitability.

It has been noted that this invention is agnostic to the equipment (223) used to distribute the oxidizing gas within the Regenerator, subject to certain conditions. The use of recycled CO₂ and high-purity oxygen, instead of air, may impact the performance of conventional air grid designs. Typically, these designs consist of a plate grid, dome grids with skirt, a flat grid with skirt, or a pipe grid. Air grids are designed to operate at temperatures up to 1,250° F. (675° C.); at higher operating temperatures, metal creep may become an issue. As such, one skilled in the art will understand that the design of conventional structures should be reviewed before implementation of this invention. Stress analysis, non-linear finite element analysis (NL-FEA), and heat-transfer analysis may be required.

In another embodiment of this invention, the oxygen concentration of the Recycle Gas/high-purity oxygen mixture (123) may be increased from 20 mol % to 35 mol %. Oxygen concentrations greater than 35 mol % are unlikely to be desirable, since the resulting temperatures may compromise catalyst function or potentially vessel integrity. By increasing the oxygen concentration, Regenerator temperatures will rise; in turn so will the Riser temperature. High-severity conditions in the Riser may be beneficial for those operations where increased cracking to lighter products such as propylene is desired. Conversely, higher Riser temperatures and increased cracking of product may be undesired. One possible solution is the use of lower-activity catalyst. However, this may place significant limits on both feedstock and product qualities. Typically, the Cat/Oil (catalyst to oil) ratio is used to manage the Riser catalyst temperature; reducing the Cat/Oil ratio reduces the reaction temperature in the Riser. However, this reduces conversion rate and yield of desired products. In these situations, a Catalyst Cooler (219) may be beneficial in enabling high temperature operation of the Regenerator without a need for significant Cat/Oil ratio changes or increased Riser temperatures.

In one embodiment a Catalyst Cooler is utilized to manage the catalyst temperature to the Riser. A Catalyst Cooler (219) is, essentially, a vertical heat exchanger. Those skilled in the art will recognize that like all aspects of FCC design, catalyst coolers come in various configurations; FIG. 2 features one such configuration. Hot catalyst enters the top (215) of the Catalyst Cooler where it proceeds down through the vessel. The catalyst is maintained in a fluidized state via a gaseous medium (228), air is typically used in existing art. In this embodiment a portion of the Recycle Gas is used as the fluidizing medium or lift gas. A heat exchanger (221), usually a shell and tube type, sits vertically within the cooler vessel. Water or saturated steam flows through the tube side of the exchanger; heat is transferred from the catalyst and fluidizing medium. Cooled catalyst exits the bottom of the cooler, returning to the Regenerator via a standpipe (229) through which a lift gas, again typically air, is provided. In many designs, the fluidizing medium disengages from the catalyst in the upper section (214) of the cooler vessel, subsequently entering (212) the Regenerator where it mixes with flue gas. Catalyst flowrate is managed by the lift gas velocity in the standpipe and separately, slide valves (217, 230). One embodiment of this invention replaces the use of air as catalyst lift gas with Recycle Gas. In another embodiment a ratio of Recycle Gas a mixture of 0 mol % to 35 mol % oxygen and 65 mol % to 100 mol % Recycle Gas is used as fluidizing and lifting gas. The larger heat capacity of carbon dioxide or carbon dioxide/oxygen mixture enables more heat to be removed for a given exchanger size. Consideration must be given to operational performance and safety when designing Catalyst Coolers when using this alternative fluidizing medium.

Regenerator combustion gases will contain entrained catalyst particles. Without removal, these particulates will cause significant damage in downstream operations such as power recovery turbines, recycle compressors, and other equipment. Existing art employs gas cyclones (207 and 209) to separate the catalyst from the gas. Consideration must be given to how changing the flue gas composition may affect cyclone separation efficiency. When using a 1-to-1 replacement ratio of Recycle Gas to nitrogen operational impacts should be minimal as velocities should remain similar; density and viscosity differences may still have an operational impact. If the ratio is altered, changes in superficial velocities within the vessel and cyclones may change separation efficiency.

Flue gas, largely cleaned of catalyst particles, exits the Regenerator (206) where it will undergo additional cleanup. It is not uncommon to utilize a third or even fourth stage separator (114). Further downstream processing may include electrostatic precipitation to remove the finest particles.

Regenerators are operated in one of two modes—partial burn, or full burn. When operating in a partial burn mode a deficit of combustion air is supplied resulting in production of carbon monoxide. The carbon monoxide is subsequently combusted to carbon dioxide in a CO boiler (109). In full burn mode, an excess of air is provided to the regenerator resulting in low carbon monoxide production. In full burn scenarios, flue gas oxygen levels are preferably maintained between 0.4% to 3% on a molar basis. Too much oxygen can result in excessive NOx production and risk afterburn of remaining carbon monoxide above the bed, in the cyclones, or the flue gas. Afterburn is of particular concern. Without a mass of catalyst to absorb the heat of combustion of CO to CO₂, the flue gas temperature will rise. This can lead to various undesirable effects such as equipment damage and lower Riser temperatures, as the catalyst is not absorbing this thermal energy.

One embodiment of this invention replaces the air used for combustion in the CO boiler with a portion of the Recycle Gas (107) and a portion of the high-purity oxygen (111), forming a mixed stream (108) fed to the CO boiler in FIG. 1. As with the Regenerator, care should be taken in selecting the ratio of Recycle Gas to high-purity oxygen. When using between 20 mol % and 35 mol % oxygen (as in the Regenerator), more-typical temperatures may range from 1,200° F. (650° C.) to 1,800° F. (980° C.). The resulting combustion gases will, as with the Regenerator flue gas, be rich in carbon dioxide due to the elimination of nitrogen and other components found in air.

In existing art, atmospheric nitrogen can lead to the production of significant quantities of nitrous oxides, ammonia and other nitrogenous compounds in the Regenerator and CO boiler. Replacing air with a Recycle Gas/high-purity oxygen mixture can significantly reduce production of these compounds. However, as the coke on the catalyst will contain some nitrogen from the feedstock, it is unlikely that production of these compounds can be fully eliminated. Likewise, oxides of sulfur (SOₓ) may be created during cracking of the feedstock. If these oxides are allowed to build up in the Recycle Gas stream, they can react further, forming compounds that can foul and corrode downstream equipment. It is therefore necessary to remove, or more practically, significantly reduce the presence of these compounds in the flue gases (105) of the Regenerator and, if used, the CO boiler. Existing art teaches methods to remove these oxides of sulfur, oxides of nitrogen, and particularly water from the Regenerator and CO boiler flue gas. The removal of these compounds by such equipment (101) will thus increase the carbon dioxide concentration of the Recycle Gas stream to greater than 90 mol %. The difference will comprise light hydrocarbons, and small quantities of hydrogen, nitrogen, oxygen, and other gases.

The treated stream is split into Recycle Gas (104) as used by preferred embodiments of this invention, and net process gas (102). The split will depend on process requirements but typically ranges in volume from 70% to 98% as Recycle Gas and 2% to 30% as net process gas. The net process gas proceeds to the CO₂ recovery system (103). The Recycle Gas typically undergoes compression (Recycle Blower in FIG. 1) to some suitable pressure to enable its various uses. Additional compression may be required for certain embodiments, not indicated in FIG. 1. Those skilled in the art will understand where and how compression devices may be required.

In FIG. 2, the hot, regenerated catalyst is returned to the Reactor-Riser (218) by a standpipe (220), the flowrate being controlled by a slide valve (225). Here, the catalyst is maintained in a fluidized state by a gas introduced by a dispersion ring (210). In conventional FCC art, air or steam is used. In one embodiment of the present invention, this air or steam is replaced with a combination of (a) air and/or steam and (b) Recycle Gas in a ratio from 0.0 (no air or steam) to 1.0 (all air and/or steam). As in embodiments where air or steam have been substituted with Recycle Gas, consideration should be given to any effects the change in physical properties may have on the associated physical devices.

From the standpipe (220), the hot regenerated catalyst at between 800° F. (430° C.) to 1380° F. (750° C.) enters the bottom (227) of the Riser (218), a vertical tube, typically 100 ft (30 m) to 130 ft (40 m) in height. An inert lift gas, typically steam in existing art, is used to fluidize the hot catalyst. Existing art teaches various methods for design and placement of equipment for dispersing the lift gas into the Riser base. The present invention is largely agnostic to the exact design employed. The lift gas accelerates the catalyst up the lower Riser (226) to the feedstock injectors. This promotes uniform flow over the Riser cross-section. Ensuring uniform flow at the point of feedstock injection limits back-mixing and prevents early excessive coking.

One embodiment of this invention replaces the use of steam as a lift gas with a portion of the Recycle Gas (124). Recycle Gas, being predominantly carbon dioxide, at temperatures and pressures typically found at the Riser base, is nearly three times as dense as steam. Typical residence times in the Riser range from as little as 1 second to as much as 10 seconds. This equates to velocities between 6 ft/s (1.8 m/s) to as much as 80 ft/s (24.5 m/s); velocity is not linear through the Riser height. As feedstock is injected and vaporized, the expanding vapor and cracked products accelerate up the Riser. It is expected that residence times will be similar whether steam or Recycle Gas (or a combination thereof) is used, assuming catalyst activity is the same. Selection of residence time, for a given operating temperature and pressure, will define the extent of cracking reactions. Too high a residence time can lead to over-cracking of the feedstock, forming lower-value products.

Existing use of steam may have a beneficial impact on the acid function of the zeolitic catalysts typically used in FCC units by reducing pore plugging by metals. Various catalyst formulations and additives exist that may be used to operate effectively in an anhydrous environment. The higher density of carbon dioxide compared to steam may alter the pressure drop up the Riser. It may also affect uniform distribution of catalyst and dispersion of the feedstock; one skilled in the art can verify whether a conventional Riser design is adequate. The use of existing designs should be evaluated to ensure density and viscosity of the lift gas are within specification.

For a conventional steam-based lift gas system, steam pressure is constrained, ranging from 10 psig (0.68 barg) to as much as 50 psig (3.4 barg), most typically 20 psig (1.4 barg). This sets a lower bound on the steam temperature, the bound being the steam saturation temperature at a given pressure. When using Recycle Gas, no such constraint practically exists. This introduces another control variable for Riser temperature management, and uniquely, an ability to reduce the Riser temperature. By reducing the temperature of lift gas, catalyst and riser temperatures will also be reduced. Importantly, this is achieved without changing Regenerator operating temperatures or Catalyst Cooler duty, or requiring a change in the Cat/Oil ratio.

Another embodiment uses a mixture of steam and Recycle Gas as the lift gas. The ratio of Recycle Gas to steam could vary from 0.0 (all steam) to 1.0 (no steam). Such a mixture can yield better overall results than the use of steam or Recycle Gas alone. Retaining the use of at least some steam may mitigate issues with zeolite catalyst acid function. This may reduce or mitigate the need for catalyst additives or special formulations as may be required when using Recycle Gas alone. Other issues related to dispersion of the catalyst may also be mitigated as the steam/Recycle Gas mixture density is decreased versus Recycle Gas alone.

Existing FCC units are typically located in refineries and thus primarily (but not exclusively) receive feedstock from the atmospheric and vacuum crude distillation units. This feed typically comprises the heavier atmospheric and lighter vacuum fractions of crude oil, with boiling ranges from 570° F. (300° C.) to 1022° F. (550° C.). This range usually encompasses atmospheric gas oil and vacuum gas oil fractions. Modern FCC units can process a wide range of feedstocks-high-severity operation can allow FCC units to manage boiling points in excess of 930° F. (500° C.). Such fractions include asphaltene heavy atmospheric column bottoms and heavier vacuum column products.

The present invention is not limited to the FCC feedstock being derived from crude oil. Non-crude sourced feedstocks can include bio-sourced oil, Kerogenate (pyrolyzed oil shale products), recycled pyrolyzed products, oils and fats, and other recycled hydrocarbon products and heavy oil. In certain situations, and with appropriate pre-processing, materials such as tires, road, roofing and paper asphalt, plastics, and other “solid” hydrocarbon-based feedstocks may be used as FCC feedstocks. Feedstocks may be shredded or otherwise treated, and may be directly mixed with catalyst in the base of the Riser. Alternatively, a feedstock may be pyrolyzed into a liquid, which serves as the FCC feedstock.

With reference to FIGS. 1 and 2, feedstock (132) is injected near the base of the Riser (125, 218). In situations where multiple feedstocks are to be processed, multiple feed injector locations may be used. Using multiple injection points rather than mixing the various feedstocks can realize several benefits. Such benefits can include selection of the initial temperature at which the feedstock contacts the catalyst, and prevention of any undesirable reactions. With some feedstocks, it may be preferable to alter the nature of the dispersant used, and different injection arrangements permit such use.

While there are many different Riser feedstock injector designs, they all have the same objective—atomization of the feedstock. Smaller droplet sizes enable rapid heat transfer from the catalyst and lift medium, leading to faster vaporization. Proper injector placement optimizes the spray pattern across the Riser cross-section, improving mixing, further enhancing vaporization. In existing art, superheated steam is typically used to disperse the feedstock via injectors. Steam (typically around 2 wt % for gasoil feeds and up to 5 wt % for heavy resid feeds) lowers the hydrocarbon partial pressure, further enhancing atomization of the feedstock. Typical temperatures for injector steam are between 380° F. (195° C.) and 600° F. (315° C.), with pressures between 180 psig (12.5 bar) to 1000 psig (70 bar). The selected injector configuration and operating pressure depends on the design and operational requirements of the FCC; it is a trade-off between sufficient atomization and the energy required to achieve it.

One embodiment of this invention replaces the use of steam in the feedstock injectors with a portion of the Recycle Gas (128). Under any sensible injector operating regime, Recycle Gas will be non-condensable. Thus, feedstock injection temperatures and pressures can be varied over a significantly greater range compared to the use of steam alone. As with other embodiments of this invention, consideration must be given to how the different physical properties of the Recycle Gas and steam may affect equipment design and operation. Recycle Gas has a significantly higher density, and a lower heat capacity than that of steam. This can affect mass flowrates through the injectors. Further consideration should also be given to other properties such as surface tension; injector nozzle designs should be evaluated with these considerations in mind. There are other benefits in eliminating steam, such as reducing issues of corrosion, scaling, and fouling. Similarly, the capacity of equipment necessary to remove condensate and sour water downstream of the reactor can be re-evaluated, and potentially eliminated.

Another embodiment of this invention replaces steam to the injectors with a mixture of steam and Recycle Gas. In this embodiment the ratio of Recycle Gas to steam may vary from as little as 0.0 (all steam), to as much as 1.0 (no steam). Such an embodiment enables the operator to select the mix of dispersion gases to best suit operational and economic considerations. Careful review of injector nozzle design must be performed based on the selected dispersion mixture and required operating conditions.

The atomized feedstock is brought into contact with hot catalyst which has been fluidized by the lift gas (227) within the lower riser (226). In conventional art, the lift gas is steam. The hot catalyst vaporizes the feedstock and the expanding vapors and lift gas along with the fluidized catalyst travels up the Riser. Average Riser operating temperatures range between 900° F. (480° C.) and 1100° F. (600° C.). Catalytic cracking occurs mostly in the upper Riser, wherein the heavy feedstock is converted to lighter products.

Internal devices (e.g., 204) at the top of the Riser (205) are designed to ensure cracking reactions are quickly terminated. There are many different configurations for the Riser termination equipment; two such examples are UOP's Vortex Separation System (VSS) and Vortex Disengager Stripper (VDS). The invention described here is agnostic to the configuration of the termination device.

The Riser vapors with entrained catalyst, at between 900° F. (482° C.) and 1,000° F. (538° C.), enter the Reactor body (202). In typical designs, the Reactor can be thought of more as a separation and disengaging vessel than as a chemical reactor. It contains a series of gas cyclones (201), usually comprising at least two stages; processed through these, catalyst load in the vapor is significantly reduced.

When using an embodiment of this invention that replaces or augments the use of steam as a lift gas in the Riser (or dispersant in the feedstock injectors) with Recycle Gas, attention must be given to potential effects on design and operation of the termination system. Termination systems such as VSS and VDS essentially operate by rapidly changing the direction of flow. It is considered unlikely that a change of lift gas (or feedstock injector dispersant) will have much effect on the terminator efficiency of conventional designs. However, physical properties such as the effects of the density and viscosity of the recycled flue gas on cyclone efficiency must be considered. Given that the catalyst particle size is unchanged whether using steam or Recycle Gas, the denser flue gas could result in improved separation due to inertial and centrifugal effects. Further, the higher-density gas will incur a higher pressure drop through the upper reactor and cyclones, which may be beneficial.

The product vapor, largely free of entrained catalyst, exits the top of the Reactor (117, 200) where it proceeds to separation (111, 115, 126). Recovered catalyst exits via the cyclone dip legs (203) to the top of the Stripper section (208) where it combines with catalyst separated via the Riser termination equipment.

The Stripper section recovers any remaining lighter hydrocarbons on the catalyst. As with all aspects of the FCC, there are many different conventional designs and implementations for the Stripper; this invention is agnostic to design choice. In the version depicted in FIG. 2, catalyst moves down through the Stripper (208) which takes the form of a series of angled and vertical baffles. Existing art will typically employ steam injected via a dispersion ring (211) near the base of the Stripping section; the baffles help maximize contact time between the falling catalyst and rising stripping steam. Steam and stripped hydrocarbons exit the Reactor with the product vapor. In one embodiment of this invention, steam is replaced as the stripping agent by Recycle Gas. In another embodiment, a combination of steam and Recycle Gas may be used. The ratio of Recycle Gas to steam may vary from 0.0 (all steam) to 1.0 (no steam). Design or selection of the stripping section internals including baffles and dispersion ring would give due consideration of the selected stripping gas. Effects to be considered include catalyst holdup times due to density differences, and stripping effectiveness due to changes in heat capacity.

Product leaving the top of the Riser-Reactor (117, 200) proceeds as noted to separation. Depending on FCC operation, the flow of light gases may be significant, particularly where carbon dioxide is used to replace steam. These vapors will be, effectively, non-condensable under normal operating conditions; column condenser temperatures range from 95° F. (35° C.) to 158° F. (70° C.). Reducing the load of these gases in the FCC Main Column (126) may improve performance and reduce both capital and operating costs. One embodiment of this invention includes a pre-flash vessel or column (115) before the FCC Main Column (126) to separate the light and non-condensable gases. One skilled in the art may recognize the need in this scenario to first cool the vapor before pre-flashing; this would require the addition of suitable heat-exchange equipment. A pre-flash may minimize FCC Main Column gas loading, condenser duty and associated design complications. Further, a pre-flash may aid in reducing issues with mist formation in the Main Column. The Pre-Flash may be designed and operated such that it minimizes loss of heavier hydrocarbons (C₆₊) in the Pre-Flash vapor. An advantage of this embodiment is the reduction or elimination of steam (if used) processed through the FCC Main Column, since it predominantly leaves as vapor from the pre-flash. This can simplify the design and operation of the Main Column condenser and related separation equipment. Condensation and separation of steam can be a source of additional maintenance.

Pre-Flash vapor (113) exits and proceeds to the Gas Processing Plant (111). The liquid product (120) is processed to the FCC Main Column. Products from this column include light ends (sent to the Gas Processing Plant), Heavy Cracked Naphtha (HCN), Light Cycle Oil (LCO), Heavy Cycle Oil (HCO), and Slurry (distillation bottoms stream). Heavy Cycle Oil (129) can be recycled as feedstock to the Riser (119) for further cracking. Distillation is a well-understood and long-practiced art; those using this invention are expected to understand how to optimize the column for the desired product fractions.

The Gas Processing Plant (111) is responsible for handling the gaseous products or light ends (121) of the FCC Main Column and Pre-Flash. The gases from these units will be comprised of many components, light hydrocarbons (C₁ through C₆), oxides of sulfur and nitrogen, water vapor, carbon monoxide, and carbon dioxide being the most notable. The design of this section will depend on the desired products, such as propylene, fuel gas, and light cracked naphtha (LCN). Some of these products such as propylene are becoming increasingly valuable. Fuel gas can be sent (110) to the CO boiler or combusted elsewhere to generate power and/or steam. Where Recycle Gas is used in the Riser-Reactor, as a lift gas or feedstock dispersant, the carbon dioxide it contains (along with other unseparated light gases) can be recycled (106) to the NOₓ, SOₓ, and H₂O cleanup process (101). All the processes required are well understood, pre-existing art.

Energy recovery is common to existing FCC art, and it is also preferred for this invention. Hot flue gases can be used to drive one or more power recovery turbines (112), generating electrical energy. This electrical energy can be used throughout the plant, but replacement of fossil fuel fired heaters with electrical resistance heaters may significantly improve efficiency and further reduce environmental impact. Where a CO boiler is employed, steam may be generated for use elsewhere in the process.

In some embodiments (not shown in FIG. 1), it may be beneficial to combust some of the cracked products. In these cases, combined heat and power (CHP) may be employed to maximize energy recovery. As with the Regenerator and CO boiler, a mixture of Recycle Gas and high-purity oxygen may replace the air normally used for combustion. The resulting flue gases may be combined with those from the CO boiler and treated for NOₓ, SOₓ, and/or H₂O removal (101).

A key environmental concern for both existing and new processes and energy technologies is reducing the release of carbon dioxide. Carbon Capture, Utilization, and Storage (CCUS) is the umbrella term for techniques and technologies to achieve this goal. There is significant existing art that can teach suitable methods for recovering carbon dioxide from industrial process. The most common approach is DEA/MEA (amine) absorption/desorption, other approaches include cryogenic, supersonic, pressure-swing adsorption, calcium-looping, and membrane separations.

Selection of a suitable CCUS technology would typically be driven by economics; this invention is agnostic to the method used. However, those aware of the art involved will see that certain techniques may be preferable. Amine-based absorption of carbon dioxide requires significant resources, water, energy, capital cost and MEA/DEA replacement and treatment costs. As the carbon dioxide concentration increases, these requirements and costs become uneconomical; 40 mol % carbon dioxide is typically considered the maximum economically viable concentration for amine-based recovery. Preferred embodiments of this invention will result in a carbon dioxide stream of over 90 mol % carbon dioxide concentration. At high concentrations of CO₂, cryogenic separation, pressure-swing adsorption, and other methods may bring economic and environmental benefits.

By avoiding the use of air (with its nitrogen and other components) for combustion, the volume of gas sent to the carbon dioxide recovery unit (103) will be reduced by up to 80%. Thus, regardless of the selected technology, capital cost will be reduced as a smaller plant will be required than if nitrogen were present.

Recovered carbon dioxide can be used either on site in other processes, stored, sequestered, or sold as a valuable industrial gas. The availability of processes for the efficient conversion of carbon monoxide and carbon dioxide to methanol is particularly attractive. Certain recovery technologies can bring the final concentration of carbon dioxide to over 99 mol %. At this concentration it becomes attractive for further downstream processing and use in industrial applications including use as a chemical reactant (such as conversion of CO₂ to methanol, ethanol, or energy-dense hydrocarbon fuels), use in food and beverages, and for medical supply. In situations where the process is near oil extraction facilities, sequestration can be combined with enhanced oil recovery. Some level of on-site storage of the carbon dioxide is preferably maintained to provide a ready volume for startup, purging and other operations.

Some variations provide a process of converting a hydrocarbon feedstock to multiple products, the process comprising:
(a) providing a starting hydrocarbon feedstock;
(b) conveying the starting hydrocarbon feedstock to a riser reactor, wherein the riser reactor is configured to receive a catalyst to catalytically crack the starting hydrocarbon feedstock and to generate riser-reactor reaction products, wherein the catalyst is fluidized by a lift gas, and wherein the catalyst becomes a coked catalyst within the riser reactor;
(c) transferring the coked catalyst to a regenerator, configured to oxidize the coked catalyst with a coke-oxidation gas, to form a regenerated catalyst and a carbon-oxides stream, wherein the coke-oxidation gas contains from about 9 mol % to about 35 mol % oxygen and from about 50 mol % to about 90 mol % carbon dioxide;
(d) transferring the regenerated catalyst from the regenerator to the riser reactor; and
(e) fractionating the riser-reactor reaction products in a FCC main column, to generate light ends, heavy cracked naphtha, light cycle oil, heavy cycle oil, and a bottoms stream,
wherein at least a portion of the carbon dioxide, contained within the coke-oxidation gas, is obtained from at least a portion of a recycle gas, wherein the recycle gas is derived from recovering CO₂ from the carbon-oxides stream, and wherein the recycle gas contains from about 80 mol % CO₂ to 100 mol % CO₂.

In some embodiments, the recycle gas contains from about 80 mol % to about 95 mol % carbon dioxide. In certain embodiments, the recycle gas contains from about 85 mol % to about 95 mol % carbon dioxide. In various embodiments, the recycle gas contains about, at least about, or at most about 80, 81, 82, 83, 84, 85, 86, 87, 88, 89, 90, 91, 92, 93, 94, 95, 96, 97, 98, 99, or 100 mol % CO₂, including any intervening range.

In some embodiments, the coke-oxidation gas contains from about 55 mol % to about 90 mol % carbon dioxide. In certain embodiments, the coke-oxidation gas contains from about 58 mol % to about 86 mol % carbon dioxide. In various embodiments, the coke-oxidation gas contains about, at least about, or at most about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol % CO₂, including any intervening range.

In various embodiments, the coke-oxidation gas contains about, or at least about, or at most about 9, 9.5, 10, 11, 12, 13, 14, 15, 16, 17, 18, 19, 20, 21, 22, 23, 24, 25, 26, 27, 28, 29, 30, 31, 32, 33, 34, or 35 mol % O₂, including any intervening range.

In some embodiments, the lift gas comprises or consists essentially of another portion of the recycle gas. Whether or not the lift gas uses some of the recycle gas, the lift gas may contain from about 80 mol % to 100 mol % carbon dioxide, such as from about 85 mol % to about 95 mol % carbon dioxide. In various embodiments, the lift gas contains about, at least about, or at most about 80, 81, 82, 83, 84, 85, 86, 87, 88, 89, 90, 91, 92, 93, 94, 95, 96, 97, 98, 99, or 100 mol % CO₂, including any intervening range.

In some embodiments, step (b) utilizes a feedstock injector dispersant that comprises or consists essentially of another portion of the recycle gas. The feedstock injector dispersant is distinct from the lift gas. Whether or not the feedstock injector dispersant uses some of the recycle gas, the feedstock injector dispersant may contain from about 80 mol % to 100 mol % carbon dioxide, such as from about 85 mol % to about 95 mol % carbon dioxide. In various embodiments, the feedstock injector dispersant contains about, at least about, or at most about 80, 81, 82, 83, 84, 85, 86, 87, 88, 89, 90, 91, 92, 93, 94, 95, 96, 97, 98, 99, or 100 mol % CO₂, including any intervening range.

In some embodiments, the carbon-oxides stream from step (c) is fed to a CO boiler. Optionally, another portion of the recycle gas is fed to the CO boiler. Whether or not the CO boiler uses some of the recycle gas, the CO boiler may be fed a gas stream containing from about 80 mol % to 100 mol % carbon dioxide, such as from about 85 mol % to about 95 mol % carbon dioxide. In various embodiments, the gas stream fed to the CO boiler (which is distinct from the oxidant fed to the boiler) contains about, at least about, or at most about 80, 81, 82, 83, 84, 85, 86, 87, 88, 89, 90, 91, 92, 93, 94, 95, 96, 97, 98, 99, or 100 mol % CO₂, including any intervening range.

In some embodiments, the coke-oxidation gas is a first portion of the recycle gas, and the lift gas is a second portion of the recycle gas.

In some embodiments, the coke-oxidation gas is a first portion of the recycle gas, the lift gas is a second portion of the recycle gas, and step (b) utilizes a feedstock injector dispersant that is a third portion of the recycle gas.

In some embodiments, the coke-oxidation gas is a first portion of the recycle gas, the lift gas is a second portion of the recycle gas, step (b) utilizes a feedstock injector dispersant that is a third portion of the recycle gas, and a fourth portion of the recycle gas is fed to a CO boiler that receives the carbon-oxides stream from step (c).

When multiple portions of the recycle gas are used, the volumetric fraction of the recycle gas that is utilized as the coke-oxidation gas (or, utilized as part of the coke-oxidation gas) may vary, such as from about 10% to about 90%.

In alternative embodiments, none of the recycle gas is used as the coke-oxidation gas but rather is used for one or more of the lift gas, the feedstock injector dispersant, or in the CO boiler.

In some embodiments, step (e) comprises pre-flashing the riser-reactor reaction products in a FCC pre-flash unit to generate a vapor stream and a liquid stream, followed by conveying the liquid stream to the FCC main column.

In some embodiments, the heavy cycle oil from step (e) is recycled to the riser reactor.

The process is preferably continuous or semi-continuous. “Semi-continuous” means that the process overall is basically continuous, but some steps are done in batch or semi-batch. As just one example, the FCC main column may be operated, either at start-up or at steady state, as a batch distillation column.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

Although the present invention has been described in terms of the presently preferred embodiments, it is to be understood that the disclosure is not to be interpreted as limiting. Various alterations and modifications will no doubt become apparent to those skilled in the art after having read this disclosure. Accordingly, it is intended that the appended claims be interpreted as covering all alterations and modifications as fall within the spirit and scope of the invention.

What is claimed is:

1. A process of converting a hydrocarbon feedstock to multiple products, said process comprising:
(a) providing a starting hydrocarbon feedstock;
(b) conveying said starting hydrocarbon feedstock to a riser reactor, wherein said riser reactor is configured to receive a catalyst to catalytically crack said starting hydrocarbon feedstock and to generate riser-reactor reaction products, wherein said catalyst is fluidized by a lift gas, and wherein said catalyst becomes a coked catalyst within said riser reactor;
(c) transferring said coked catalyst to a regenerator, configured to oxidize said coked catalyst with a coke-oxidation gas, to form a regenerated catalyst and a carbon-oxides stream, wherein said coke-oxidation gas contains from about 9 mol % to about 35 mol % oxygen and from about 50 mol % to about 90 mol % carbon dioxide;
(d) transferring said regenerated catalyst from said regenerator to said riser reactor; and
(e) fractionating said riser-reactor reaction products in a FCC main column, to generate light ends, heavy cracked naphtha, light cycle oil, heavy cycle oil, and a bottoms stream,
wherein at least a portion of said carbon dioxide, contained within said coke-oxidation gas, is obtained from at least a portion of a recycle gas, wherein said recycle gas is derived from recovering CO₂ from said carbon-oxides stream, and wherein said recycle gas contains from about 80 mol % CO₂ to 100 mol % CO₂.

2. The process of claim 1, wherein said recycle gas contains from about 80 mol % to about 95 mol % carbon dioxide.

3. The process of claim 1, wherein said recycle gas contains from about 85 mol % to about 95 mol % carbon dioxide.

4. The process of claim 1, wherein said coke-oxidation gas contains from about 55 mol % to about 90 mol % carbon dioxide.

5. The process of claim 1, wherein said coke-oxidation gas contains from about 58 mol % to about 86 mol % carbon dioxide.

6. The process of claim 1, wherein said lift gas comprises another portion of said recycle gas.

7. The process of claim 1, wherein said lift gas consists essentially of a second portion of said recycle gas.

8. The process of claim 1, wherein said lift gas contains from about 80 mol % to 100 mol % carbon dioxide.

9. The process of claim 1, wherein said lift gas contains from about 85 mol % to about 95 mol % carbon dioxide.

10. The process of claim 1, wherein step (b) utilizes a feedstock injector dispersant that comprises another portion of said recycle gas, and wherein said feedstock injector dispersant is distinct from said lift gas.

11. The process of claim 1, wherein step (b) utilizes a feedstock injector dispersant that consists essentially of another portion of said recycle gas, and wherein said feedstock injector dispersant is distinct from said lift gas.

12. The process of claim 10, wherein said feedstock injector dispersant contains from about 80 mol % to 100 mol % carbon dioxide.

13. The process of claim 10, wherein said feedstock injector dispersant contains from about 85 mol % to about 95 mol % carbon dioxide.

14. The process of claim 1, wherein said carbon-oxides stream is fed to a CO boiler, and wherein another portion of said recycle gas is fed to said CO boiler.

15. The process of claim 1, wherein said coke-oxidation gas is a first portion of said recycle gas, and wherein said lift gas is a second portion of said recycle gas.

16. The process of claim 1, wherein said coke-oxidation gas is a first portion of said recycle gas, wherein said lift gas is a second portion of said recycle gas, and wherein step (b) utilizes a feedstock injector dispersant that is a third portion of said recycle gas.

17. The process of claim 1, wherein said coke-oxidation gas is a first portion of said recycle gas, wherein said lift gas is a second portion of said recycle gas, wherein step (b) utilizes a feedstock injector dispersant that is a third portion of said recycle gas, wherein said carbon-oxides stream is fed to a CO boiler, and wherein a fourth portion of said recycle gas is fed to said CO boiler.

18. The process of claim 1, wherein step (e) comprises pre-flashing said riser-reactor reaction products in a FCC pre-flash unit to generate a vapor stream and a liquid stream, followed by conveying said liquid stream to said FCC main column.

19. The process of claim 1, wherein said heavy cycle oil from step (e) is recycled to said riser reactor.

20. The process of claim 1, wherein said process is continuous or semi-continuous.
